(19) United States
(12) Patent Application Publication
(10) Pub. No.: US 2023/0283614 A1
(43) Pub. Date: Sep. 7, 2023

(54) SIMULTANEOUS, SESSION LEVEL EXPERIMENTATION AND EXPERIENCES DEPLOYMENT

(71) Applicant: WarnerMedia Direct, LLC, New York, NY (US)

(72) Inventors: Hazel Diana Mary, East Norriton, PA (US); Erik Fortune, Redmond, WA (US); Michael Magpayo, New York, NY (US); Ivan Follender, New York, NY (US)

(21) Appl. No.: 17/653,450

(22) Filed: Mar. 3, 2022

(51) Int. Cl. H04L 9/40

(52) U.S. Cl. CPC H04L 63/105; H04L 63/107; H04L 63/108

(57) ABSTRACT

The described technology is generally directed towards a system that facilitates interaction with an environment (e.g., a streaming service provider's platform) in a way that allows users with appropriate privileges simultaneous, privileged session-level experiences and experimental interactions with the environment's components. Via a session override, the technology allows a user associated with an authorized role to select among multiple, simultaneously available configurations to receive a different experience for a privileged session from that of any other general user. A privileged user can switch configurations as desired for different per-session experiences. A session context object can contain the override payload for sending to services that respect the override, which allows the desired client user experience in the environment

### BACKGROUND

Building and testing multiple end-to-end experiences of a product in parallel, such as components or subsystems of a globally deployed video streaming platform, needs to performed to isolate issues and attribute those issues to the responsible components and/or subsystems. A typical way to configure multiple experiences simultaneously in parallel is to use service specific flags, a preset configuration for a set of flags, environment variables and/or global feature flags across services and the like. However, such flags and variables are tied to a runtime instance of the binary, whereby requests to those services access the same configuration.

Another way to support multiple experiences simultaneously in parallel in an environment is to hard code certain accounts or device identifiers of certain users to use a certain alternate configuration. In general, this is not scalable and is basically a “hack.” Switching between configurations is difficult in such scenarios as well; often a code change is needed to switch the instance to which the user connects, or an account needs be hardcoded to a specific instance.

Another, process-based solution to reuse the same environment for multiple experiences is to sequence them partially; (for example, one program might be in integration and quality assurance, and the other in development). These types of solutions highlight the friction and complexity of having multiple experiences use the same environment simultaneously, and thus are not ongoing, steady state solutions.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of a system in which client device can obtain a context object with a session override based on a configuration dataset, in accordance with various aspects and example implementations of the subject disclosure.

FIG. 2 is an example block diagram representation of a privileged session client (a client of a privileged session) that uses a context object with a session override to access services of another region, in accordance with various aspects and example implementations of the subject disclosure.

FIG. 3 is an example block diagram representation of a privileged session client that uses a context object with a session override to access services at a future time, in accordance with various aspects and example implementations of the subject disclosure.

FIG. 4 is an example block diagram representation of a privileged session client that uses a context object with a session override to access services of non-launched build, in accordance with various aspects and example implementations of the subject disclosure.

FIG. 5 is an example block diagram representation of a privileged session that receives one experience via one dataset of a service distinguishable from another experience of another, different dataset for non-privileged session clients, in accordance with various aspects and example implementations of the subject disclosure.

FIG. 6 is a sequence diagram of example communications/dataflow between various services that configure a client device via a context object with a session override as described herein, in accordance with various aspects and example implementations of the subject disclosure.

FIG. 7 is a flow diagram of example operations related to accessing an otherwise inaccessible service based on an override privilege to obtain data, in accordance with various aspects and example implementations of the subject disclosure.

FIG. 8 is a flow diagram of example client device operations related to generating an override payload based on the configuration data for returning to a client device, in accordance with various aspects and example implementations of the subject disclosure.

FIG. 9 is a flow diagram of example operations related to obtaining configuration data corresponding to a particular user experience, and sending an override payload based on the configuration data to the client device for use during a client device session to allow the user experience in an environment, in accordance with various aspects and example implementations of the subject disclosure.

FIG. 10 is a block diagram representing an example computing environment into which aspects of the subject matter described herein may be incorporated.

FIG. 11 depicts an example schematic block diagram of a computing environment with which the disclosed subject matter can interact, in accordance with various aspects and implementations of the subject disclosure.

### DETAILED DESCRIPTION

The technology described herein is generally directed towards facilitating interaction with an environment (of a platform such as a streaming service provider's platform) in a way that allows certain users simultaneous, session-level experimentation interactions and experiences with the environment's components. In one implementation, a client becomes privileged because the user (e.g., with appropriate credentials) makes a session privileged. This can be because the client is a privileged client or the user did something to make the session privileged, for example, the user used a specific account, the user used a pre-configured device that is configured as privileged, the user obtains a privileged session via a one-time passcode, and so forth.

The technology allows a user associated with an authorized role to select among multiple, simultaneously available configurations, and thereby opt into a configuration at any time to receive a different experience from that of any other general user for a privileged session. A user can switch configurations as desired among one or more roles to which the user is authorized to act, and if desired can have multiple sessions with different configurations running in parallel, e.g., on different devices.

By way of example, consider that a non-privileged session of a user currently located in the United States has logged into a streaming service platform, and, for example interacts with a client application program coupled to the platform to receive a catalog of streaming content offerings available in the United States, along with other aspects of a United States user experience. A privileged session, such as associated with an employee user who needs to test some aspect of the platform, also currently located in the United States, has logged into the streaming service platform, that is, in the same environment, but with an authorized role that allows the employee user to emulate a user in the European Union, e.g., Germany, via a privileged session. In this example, although located in the United States, the user of the privileged session will receive the catalog of streaming content offerings available in Germany, along with other aspects of a European Union experience, such as prompts, data privacy rules and the like. Significantly and unlike other testing scenarios, (e.g., separate environments or builds, multiple accounts, manually adding accounts to a list per experiment and so on), with the technology described herein, no redeployment is needed, and a user operates in the same environment of services, that can include client builds . Thus, although out of a given region in the above example, the user can have the same account, opt into a privileged session, and operate in the exact same physical environment at the exact same time as the user with a non-privileged session. However, because the components (e.g., services) of the environment respect the configuration and role of the privileged session, the privileged session receives an entirely different experience (in this example the experience of a different region) from the non-privileged session.

It should be understood that any of the examples herein are non-limiting. For instance, certain example dimensions of an experience such as location, time, and/or type of user are described herein with respect to providing an experience, however these are only non-limiting examples, and other dimensions, including those not yet implemented, can be incorporated into the environment. As such, the technology described herein is not limited to any particular embodiments, aspects, concepts, structures, functionalities or examples described herein. Rather, any of the embodiments, aspects, concepts, structures, functionalities or examples described herein are non-limiting, and the technology may be used in various ways that provide benefits and advantages in computing and user interface technology in general.

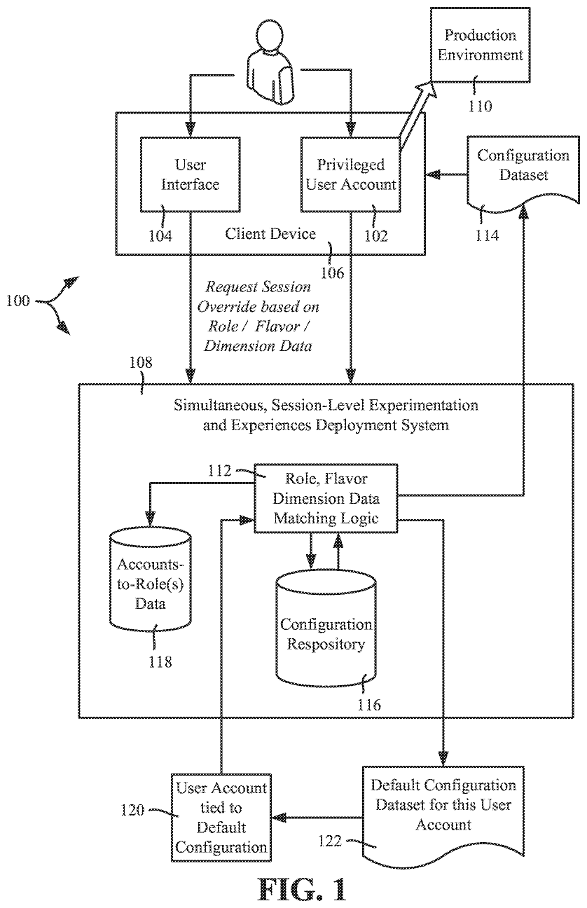

FIG. 1 is a generalized block diagram representation of an example overall system 100 in which a user with a privileged user account 102 (or using a device or the like configured with privileges) couples via a user interface 104 of a client device 106 to a simultaneous, session-level experimentation and experiences deployment system 108 or the like. As will be understood, the system 108 allows a user to operate with a device or session level override for a privileged session.

The system 108 is associated with a production environment 110, which can be a global platform accessible to client devices, such as client devices operated by valid subscribers or potential subscribers of a global streaming video content provider. The global platform can comprise services and/or microservices in various servers including cloud services or the like located worldwide. Note that “simultaneous” as used herein generally means that other users can be using the system 108 and/or the production environment 110, including regular, non-privileged session users accessing the production environment 110 at the same time.

As described herein, client devices can also be operated by a user of a privileged session to couple to the production environment 110 for various purposes. Examples of such purposes include, but are not limited to operating as an editor client, a pre-release client/a beta user client, an experiments client, a test client emulating an individual end user client, a test client emulating a vendor client, a test client emulating a supplier client, or a test client emulating a business user client. A user via a privileged session can interact with the environment for experimentation purposes, privacy data evaluation, asset purchase offering data (store keeping unit, or SKU)/entitlement evaluation, telemetry data evaluation, evaluation of a user experience (e.g., an editorial experience, an age-based experience) and so on.

Via interaction with the user interface 104, the user with the privileged user account 102 specifies a desired role, along with dimension data such as desired location, desired time data (current time or a future time) and any other dimension data that the user wants to experience for a privileged session, e.g., that of a user subscriber testing how the production environment acts when attempting to pay a bill through a (not yet active) third party bill paying service.

Rather than or in addition to specifying dimension data, the user can specify a “flavor” for the user experience, e.g., PROD (production), test, ContentOps, <newReleaseCountries>, and so forth. Such flavors can be using the same underlying infrastructure. The user can specify and/or modify any dimension data not reflected by any specified favor, and can override dimensions included in flavor definition. Further, a flavor is not needed to use overrides.

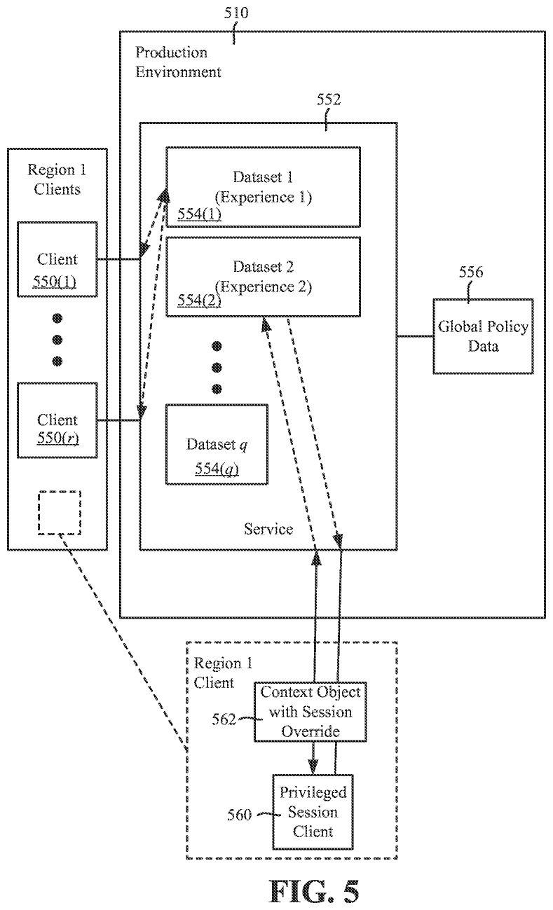

Based on the role, flavor and/or dimension data, matching logic 112 of the system 108 determines a configuration (e.g., configuration information arranged as a configuration dataset 114) that will provide the user with the desired experience. In one implementation as generally described with reference to FIG. 5, the configuration dataset is configured as part of a payload of a session context object that the client device associated with the client's communications (e.g., requests) to services; a service can attach the session context object to service-to-service calls as well.

In general, each configuration dataset corresponds to a modeled user experience corresponding to some entity that has an agency relationship with the environment, such as a user, vendor, supplier, client, business user business-to-business user, editor, or the like depending on the product. Alternatively, or in addition to, a proxy such as IP address, device identifier (ID), user ID, user group ID or the like also may be used to uniquely identify someone with agency.

For each group with agency, parameters that assist in creating a proxy of the agent's profile can be defined and used, such as SKU IDs, user/device/browser agent, languages, and so forth. Parameters can be defined for a business environment such as the physical country as defined by its political borders, regulations applicable including those from affiliated countries, and so forth. Optionally, session time can be local or a normalized time zone, and can provide a “time travel”-like capability where different experiences are available at different times is needed, e.g. in cases where an old product is being replaced with a new one in market. Parameters can be defined for other qualifiers of an experience such as brand, product, or the like. There can be preset flavors of the experience being configured.

The configuration dataset 114, which may be saved in a repository 116 or the like, is then returned to the client device 106 and used to provide the user with the desired experience in the production environment 110. The repository can be a data store, a file (set) or service where the definitions for each experience reside, are persisted and/or are computed, at least partially to leverage this capability. Optionally, feature flags may be used in conjunction with this repository for cases like features under development.

Note however that the user's account credentials need to match a role for which the user is authorized, e.g., as maintained in an accounts-to-roles data structure (e.g., a repository) 118. For example a “test” role that allows a tester to access a partitioned region of the production environment 110 from outside that region will not necessarily be given a configuration dataset related to editing future content offerings that only an authorized user with an “editor” role can obtain. A user account can be associated with one or more roles; for example, a manager may be both a tester and an editor, and possibly even more roles, and can select between such multiple roles, each of which can correspond to a flavor. Note that even if an unauthorized user obtains the ability to log in with a privileged status, such as user will receive a “no-op” or the like if not associated in the system 108 with a role.

A configuration dataset can be named and saved in the repository 116, and an authorized user (e.g., with privileges) can select among named ones, e.g., filtered by role, flavor or the like, and/or reuse a configuration dataset previously used by the privileged user or another privileged user with a similar role. A developer or other qualified person can define or edit configuration datasets, and save them for other such users to use.

For additional convenience, a user account can be tied to a default configuration (block 120). For example, a privileged user/account based on a “dedicated” identity or the like can be associated with a default configuration dataset 122, so that, for example, an individual user or team of users need only use the account/identity to obtain the default configuration dataset associated therewith. There can be different dedicated identities associated with different default configuration datasets.

In general and as described herein, configuration dataset comprises different data for different configurations within a service to which the client device is to connect, along with dimension data for connecting to those services. In one implementation, the dimension data comprises a number of variables including the example variables set forth herein.

To summarize, privileged users/devices can request overrides to obtain privileged sessions through the system 108. Each privileged session can be based on a separate role of one or many roles available to a user, e.g., teleport to a different region, time travel. The role(s) allow any privileged user/device to access different features of the environment, via override data for a privileged session.

A configuration dataset can be defined for each flavor in terms of determinants of policy, with a way to select the flavor through the environment or application, e.g., the user interface 104. For example, this could be at an environment level using device ID or user ID-based selection. Another example is to select the flavor at runtime through the application on a per-session basis, with the selection used to configure the experience. There can be governance solutions, such as (but not limited to) number of flavors, access to any or a specific flavor, access to switch flavors, access to create a flavor, expiration of a flavor, and so on.

A session that allows override can be associated with a user device via a payload. There can be cumulative overrides in which each override adds on to existing override(s) in the same session. A user can remove an override, e.g., overwriting it.

Result (e.g., telemetry) information for an experience, e.g., what the user learned and other data can be obtained from an override session. This information can be maintained in association with the configuration dataset, e.g., for reuse or use by other privileged users. Such result information can be used to modify a configuration dataset.

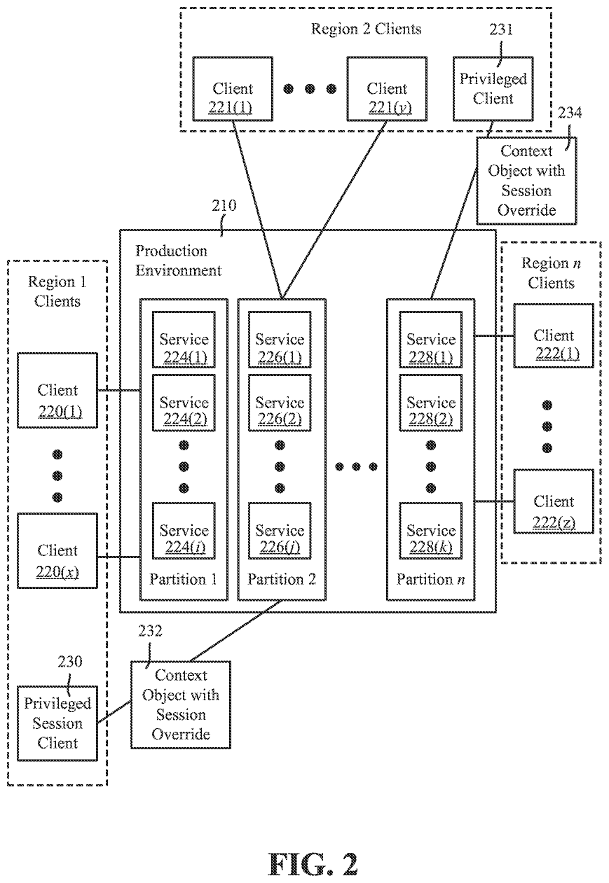

As set forth herein, the services running in an environment such as the production environment 210 of FIG. 2 can be differentiated (partitioned) by their functions, that is, a service is an instance or part of a group of instances that is capable of servicing any given request. One type of access to different partitions corresponds to test accounts with specific operational purposes, for example.

The use of the session override coordinates communication between separate services, including minor business rules, data in regions, partition-specific experiences, and so on, and data can be routed accordingly. Services determine user entitlements, provide the actual business rules, including for an out-of-region scenario in the exact same physical environment, at the exact same time as other users. Thus, for example, a tester with a privileged account can have a Latin American account, but have role based access to an override session, e.g., see to see the Sweden experience, Swedish business rules for privacy and portability and so forth.

One way in which to partition services is based on region, that is, a service can be physically located in the region in regional service clusters. Logical partitioning is another type of partitioning as described herein, e.g., the services of one brand of a product can be partitioned from the services of another brand of a product. In addition to accessing different services, a session override can change behavior, e.g., of the client application program, or some aspect of a service.

In general, and as shown in FIG. 2, the regular, non-privileged users (or privileged users not opting into a privileged session) of the environment's services are, to an extent, associated with the region in which they are currently located. Note that user data can be associated with a home region in a different partition, e.g., so that the user data of roaming users comply with their home region's data privacy and other regulations, but for the example of FIG. 2, consider that the services provide content offerings based on the region in which the client device is operating. Thus, the region 1 clients 220(1)-220(x) are limited to the content offerings of thee services 224(1)-224(i) of partition 1, the region 2 clients 221(1)-221(y) are limited to the content offerings of the services 226(1)-226(i) of partition 2, and the region n clients 222(1)-222(z) are limited to the content offerings of thee services 226(1)-226(k) of partition n.

As described herein, a user that selects to override a session for a privileged session obtains a context object with session override information therein, based on the configuration dataset, e.g., with “teleport” override capabilities. Thus, in this example, a privileged session client 230 (a client of the privileged session) actually operating in region 1 has its requests to services associated with a session override context object 232, and instead of receiving an “out-of-region” response or the like, can act as if operating as a region 2 session and thus access the services 226(1)-226(i) of partition 2. This can be used to emulate a roaming user, and/or as a user with a “home” in region 2 as well as physically operating in region 2, for example. Similarly, a privileged session client 231 actually operating in region 2 has its requests to services associated with a session override context object 233, and can act as if operating as a region n user and thus access the services 228(1)-228(k) of partition n.

For operational testing reasons or the like, a client in Latin America can thus, for example, view the content offerings in Europe during a privileged session. There can also be overrides on SKUs, overrides of business/regulatory rules, and so on. For example, a user may want to test the Swedish catalog, Swedish prompts, privacy parameter settings, restrictions, and/or the like via a session override, but when using a Spanish user account, e.g., without a session override, the user will instead get the Spanish catalog within the European Union. There can be session overrides to virtual private network (VPN) blocks.

Optionally, to use the system for physically partitioned services, deployment units can be identified, comprising a fundamental unit of scaling services for any specific physical partition of services. For example, if United States traffic goes up by ten percent, only the US deployment unit needs to be scaled. The deployment unit can apply to one or a group of microservices, with the determinants mapped to the applicable deployment partitions of that domain. The environment can support domain specific routing for this to work correctly.

Further, an option is to use the system across logical partitions in a service domain or a single or group of microservices, based on identifying the factors used to select the logical partition; (for example, brand, language, markets, and so forth). The determinants of policy are mapped to these factors. If the data is physically partitioned on these factors as well, the environment provides a way to route to the correct partition. As another option, if certain physical or logical partitions are available only in certain flavors, those flavors are mapped to include the specific partitions, other flavors mapped to exclude those partitions.

Note that the concept of authorization of a privileged session is technically optional, as there can be situations where a strong need for governance is not needed. Authorization can be granted in many ways, including, but not limited to being granted through a user, a client, an environment, one-time passcodes, a session, and so forth. It can also not be needed, such as in an environment where everyone can use the technology described herein. Notwithstanding, in general a client's devices request that is to be rerouted needs to be associated with some override capability, so that the system can know to reroute the request instead of route it conventionally.

Turning to the concept of time travel, consider that a privileged user such as with an editor role wants to view and possibly edit next week's catalog of content offerings, e.g., how they appear on a page, possibly (but not necessarily) in another physical region. By obtaining time travel session override with next week's future time, the user can access such information during a privileged session.

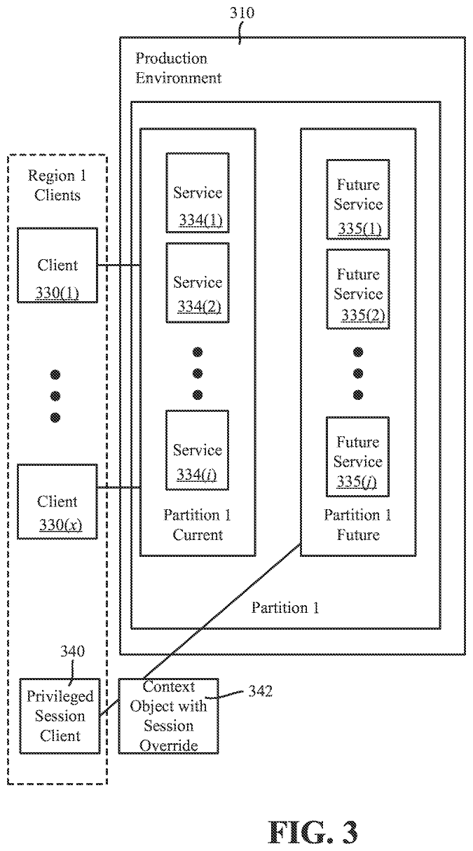

The technology described herein facilitates accessing different configurations or partitions of the same service. As shown in FIG. 3, a logical partition can be within a same physical partition, e.g., partition 1, such that regular clients 330(1)-330(x) access services 334(1)-334(i) in the current time, while a privileged session client 340 access services 335(1)-335(i) in the future time. Note that only time-sensitive services need be logically partitioned for this purpose. It should be noted that in one scenario, access to the time-travel capable services can be always allowed, but the services use the session overrides payload to decide if time-travel is allowed for the session, that is, using account level permissions.

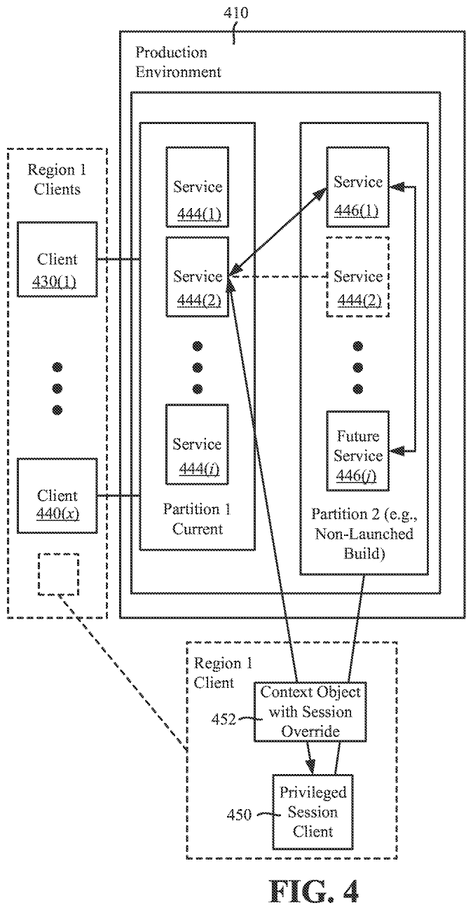

Turning to another type of partition, consider that as represented in FIG. 4, a region 1 client 450 with a testing role wants to test a non-launched build scheduled for an upcoming release, which can be in the same physical partition as a launched build, or in an entirely different region, e.g., for a Nordic launch/physical partition. A privileged session can be chosen to accomplish such a task. Indeed, if before any launch in a region, a regular or other non-privileged session client roams to the region but the launch has not happened, the regular/non-privileged session client will receive an “out-of-region” message or the like.

Thus, as can be seen, the regular, non-privileged sessoin clients have no access to partition 2, and can only access the services 444(1)-444(i), whereas a session override 452 allows the privileged session client 450 to access the non-launched services 446(1)-446(j). This allows a global technology stack to be tested in different scenarios piecewise before actually launching, as if the launch had occurred, as well as to obtain experimentation information for testing a feature for potential launch (the feature may or may never actually launch). An upcoming capability (not yet launched) can be similarly tested in this way.

FIG. 4 shows another concept, (which is applicable to the examples of FIGS. 2 and 3 as well, in addition to other scenarios), namely that a service can be accessed (e.g., 442(2)) from a different partition, that is, as a fallback to an existing service. Consider for example that a build is under development, and not all of its services are ready to test. If a service or the privileged session client 450 needs to communicate with a service that is not yet sufficiently developed (in some interim state of development), the call is routed to the service in partition 1, the service 442(2) in this example. It would also be feasible to copy the service to the other partition, but routing would still need to be to the copy, rather than the service in the interim state of development. A configuration dataset can configure which services are used together.

FIG. 5 shows another concept, (which is applicable to the examples of FIGS. 2-4 as well, in addition to other scenarios), namely that a service 552 can choose different internal sets of data 554(1)-554(q), such as based on a flavor and/or global policy data 556. Thus, for example, (non-privileged session) clients 550(1) and 550(r) receive one experience (1) based on dataset (1) 554(1), while privileged session client 550(2) with a context object with session override 558 receives another experience (2) based on dataset (2) 554(2). Some of the data such as in the dataset 554(q) can be the same for the different experiences.

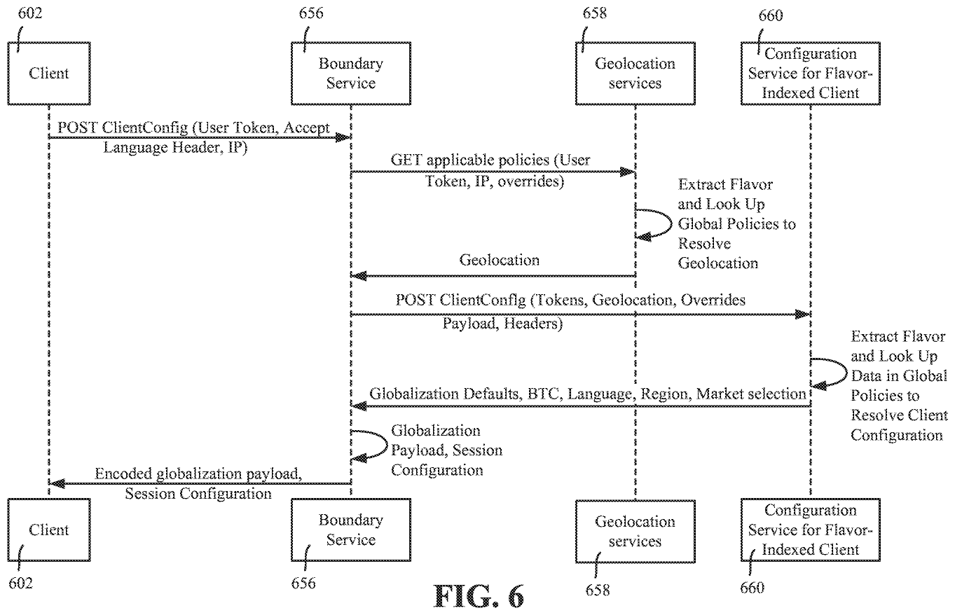

FIG. 6 is an example sequence diagram showing how a “privileged” client with an associated role obtains a privileged session override payload that is part of a session context (object) for use in subsequent communications with other services during the privileged session. In FIG. 6, to obtain session context, the client with a privileged account (properly authenticated) sends the user token and related information to a (local or global) boundary service 656. In turn the boundary service recognizes the token and sends the token and related information, including override data, to geolocation services 658, which extracts the flavor and global policy data and determines if the client is allowed to override any part of the session

In this example the session override is allowed, and thus the geolocation is returned to the boundary service 656 for (in this example) the region of the client, e.g., an override region. with this information. Based on this gathered information, the boundary service 656 posts the information to a configuration service 660 (for flavor-indexed clients), which adds further configuration data to a response to the boundary service 656. In particular, the configuration service 660 derives client aspects from the services, including any feature flags to turn on in the client. In this way, the boundary service has the globalization and session configuration data, and encodes it for creating the context object (payload). This is returned to the client device 608 via the boundary service 656.

The client then takes the configuration details to render its experience, pass its payload(s) to any other services and so on. The other services recognize the payload data and operate accordingly.

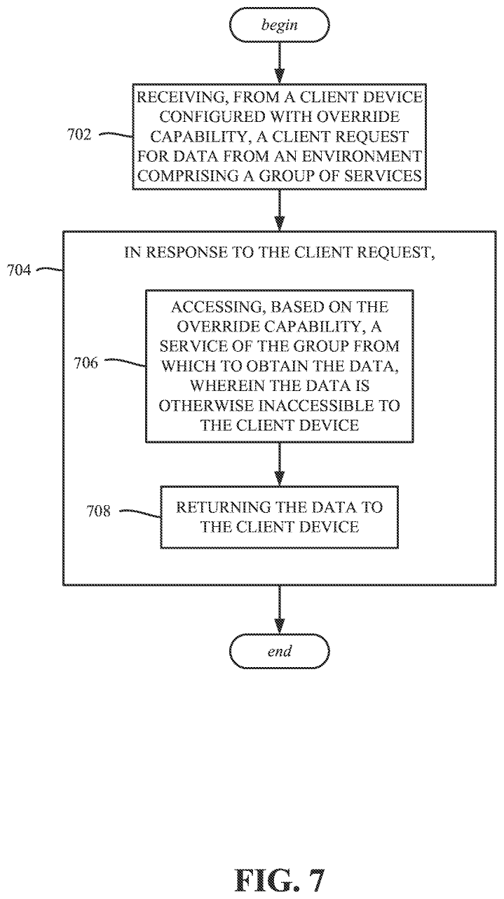

One or more aspects can be embodied in a system, such as represented in FIG. 7, and for example can comprise a memory that stores computer executable components/instructions, and a processor that executes computer executable components/instructions stored in the memory to perform operations. Example operations can comprise operation 702, which represents receiving, from a client device configured with override capability, a client request for data from an environment comprising a group of services. Operation 704 represents, in response to the client request, accessing, based on the override capability, a service of the group from which to obtain the data, wherein the data is otherwise inaccessible to the client device (operation 706), and returning the data to the client device (operation 708).

Further operations can include maintaining, in a repository, a configuration dataset, corresponding to a role of a client user in the environment, and accessing the repository on behalf of the client user to obtain the configuration dataset for the current client device session.

The configuration dataset can correspond to an experience in the environment.

The role can include at least one of: an editor client, a pre-release client/a beta user client, an experiments client, a test client emulating an individual end user client, a test client emulating a vendor client, a test client emulating a supplier client, or a test client emulating a business user client.

Further operations can include associating result information, obtained from the configuration repository, with the configuration dataset from the client.

The configuration dataset can override, for operational testing, at least one of: asset purchase offering data, business rule data, or regulatory rule data.

The client device can be located in a first location during the current session, the service can be associated with a second location that is different from the first location, and the client session can be configured with the override capability based on an override privilege. Further operations can comprise determining that the client request is associated with the override privilege for a current client device session; the service can be inaccessible to the client device when located in the first location during a different client session that is not associated with the override privilege.

The override capability can include a time travel privilege, the current session can correspond to a current time, the service can maintain future data corresponding to a time later than the current time, and the time travel privilege can allow access to the future data; the future data can be inaccessible to the client device during a different client session that is not associated with the time travel privilege.

The service can contain information for an upcoming capability or product launch that has not yet occurred, or experimentation information for testing a feature for potential launch.

Further operations can include accessing global policy data to apply policy settings to at least one of: globalization default data, language data, region data, market selection data, experimentation data, privacy data, asset purchase offering data, entitlement data, telemetry data, or user experience configuration data to set session context corresponding to the configuration dataset for override, and communicating the payload to the client device.

The payload can be incorporated into a session context object associated with the current client device session.

The environment can include functionally-differentiated instances of running services, and the service can be an instance, or part of a group of instances, that is capable of servicing requests.

The functionally differentiated instances of running services can include partitions, and a partition can correspond to at least one of a geographic location, or a brand.

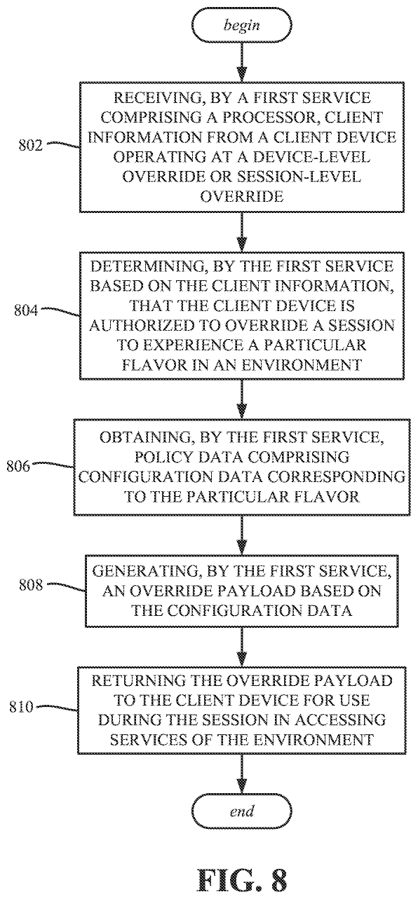

One or more example aspects, such as corresponding to operations of a method, are represented in FIG. 8. Operation 802 represents receiving, by a first service comprising a processor, client information from a client device operating at a device-level override or session-level override. Operation 804 represents determining, by the first service based on the client information, that the client device is authorized to override a session to experience a particular flavor in an environment. Operation 806 represents obtaining, by the first service, policy data comprising configuration data corresponding to the particular flavor. Operation 808 represents generating, by the first service, an override payload based on the configuration data. Operation 810 represents returning the override payload to the client device for use during the session in accessing services of the environment.

Additional operation(s) can include at least one of: allowing access to a second service based on the override payload, in which the second service is inaccessible during a different session that is not based on the override payload, or changing behavior based on the override payload.

The client device can be located in a first geolocation, and additional operation(s) can include at least one of: changing behavior based on the override payload, or allowing access, based on the override payload, to a second service located in a second geolocation, in which the second service is inaccessible from the first geolocation during a different session that is not based on the override payload.

Additional operation(s) can include allowing access, based on the override payload, to a second service that accesses future data in response to a request from the client device during the session.

The session can be a first session, the services of the environment can be a first group of services, the override payload can be a first override payload, and additional operation(s) can include returning a second override payload to the client device for use during a second session in accessing the first group of services of the environment.

The session can be a first session, the services of the environment can be a first group of services, the override payload can be a first override payload, and additional operation(s) can include returning a second override payload to the client device that adds to the first override payload.

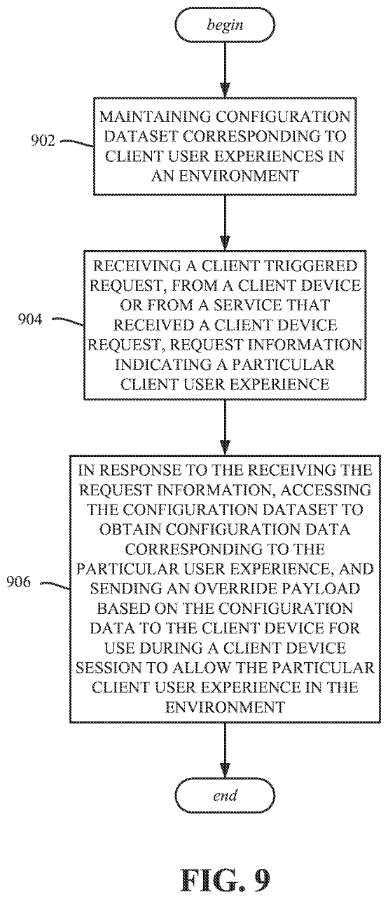

FIG. 9 summarizes various example operations, e.g., corresponding to executable instructions of a machine-readable medium, in which the executable instructions, when executed by a processor, facilitate performance of the example operations. Operation 902 represents maintaining a configuration dataset corresponding to client user experiences in an environment. Operation 904 represents receiving a client triggered request, from a client device or from a service that received a client device request, request information indicating a particular client user experience. Operation 906 represents, in response to the receiving the request information, accessing the configuration dataset to obtain configuration data corresponding to the particular user experience, and sending an override payload based on the configuration data to the client device for use during a client device session to allow the particular client user experience in the environment.

Further operations can include routing a client request, based on the particular client user experience, to a service associated with the particular client user experience.

As can be seen, there is described a technology that provides configurations at a session level, as opposed to different environments or user or device level test scenarios. Users can opt into a configuration easily and deterministically for a session. The technology reduces lead time in testing multiple large initiatives in parallel, resulting in a quicker time to market, and does so without hacks and temporary solutions that do not make it to an actual production environment.

Software and infrastructure deployment for a new cluster/region can be completely independent of each other. Using back-up paths to a different cluster/region, the technology provides a usable environment of a working product while parts of another cluster/regions are being built to ensure infrastructure deployment. A new infrastructure can be tested, e.g., without knowing all the specific APIs needed for testing at lower levels of the stack.

The central repository with experience definitions facilitates having multiple configurations in parallel in the same environment, allowing selection of a configuration on a per-session basis. A centralized experience definition repository increases control across service domains in the product, and facilitates the correct attribution of issues to a certain configuration.

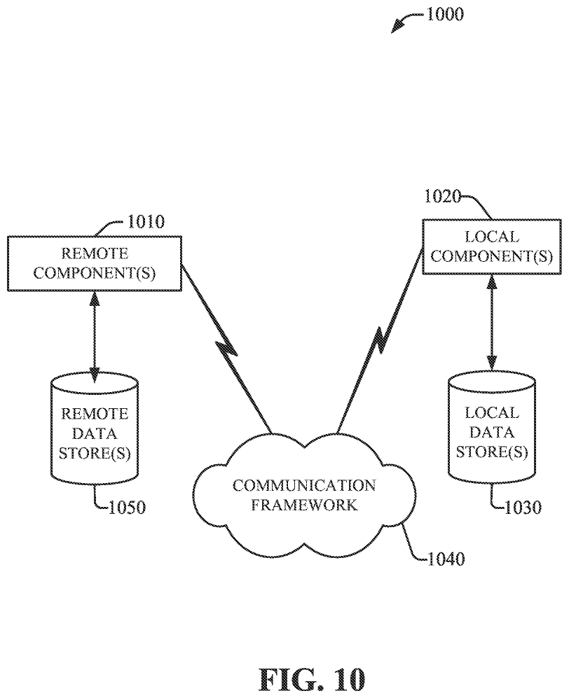

The techniques described herein can be applied to any device or set of devices (machines) capable of running programs and processes. It can be understood, therefore, that personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below in FIG. 10 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 10 thus illustrates a schematic block diagram of a computing environment 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010 and 1020, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

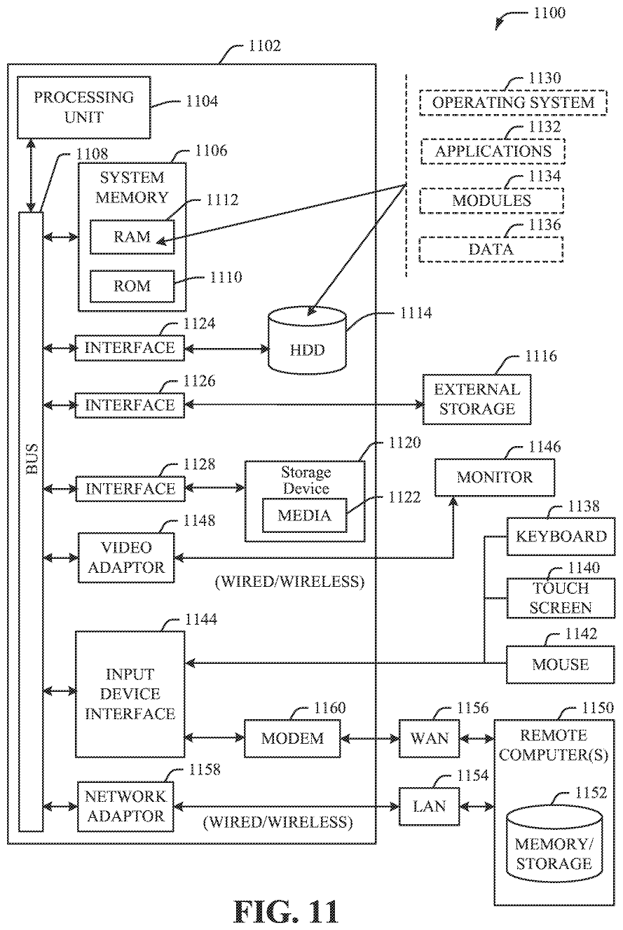

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather is to be construed in breadth, spirit and scope in accordance with the appended claims.

What is claimed is:

1. A system, comprising:
a processor; and
a memory that stores executable instructions that, when executed by the processor of the system, facilitate performance of operations, the operations comprising:
receiving, from a client device configured with override capability, a client request for data from an environment comprising a group of services; and
in response to the client request,
accessing, based on the override capability, a service of the group from which to obtain the data, wherein the data is otherwise inaccessible to the client device; and
returning the data to the client device.

2. The system of claim 1, wherein the operations further comprise maintaining, in a repository, a configuration dataset, corresponding to a role of a client user in the environment, and accessing the repository on behalf of the client user to obtain the configuration dataset for the current client device session.

3. The system of claim 2, wherein the configuration dataset corresponds to an experience in the environment.

4. The system of claim 2, wherein the role comprises at least one of: an editor client, a pre-release client/a beta user client, an experiments client, a test client emulating an individual end user client, a test client emulating a vendor client, a test client emulating a supplier client, or a test client emulating a business user client.

5. The system of claim 2, wherein the operations further comprise associating result information, obtained from the configuration repository, with the configuration dataset from the client.

6. The system of claim 2, wherein the configuration dataset overrides, for operational testing, at least one of: asset purchase offering data, business rule data, or regulatory rule data.

7. The system of claim 1, wherein the client device is located in a first location during the current session, wherein the service is associated with a second location that is different from the first location, wherein the client session is configured with the override capability based on an override privilege, and wherein the operations further comprise determining that the client request is associated with the override privilege for a current client device session, wherein the service is inaccessible to the client device when located in the first location during a different client session that is not associated with the override privilege.

8. The system of claim 1, wherein the override capability comprises a time travel privilege, wherein the current session corresponds to a current time, wherein the service maintains future data corresponding to a time later than the current time, wherein the time travel privilege allows access to the future data, and wherein the future data is inaccessible to the client device during a different client session that is not associated with the time travel privilege.

9. The system of claim 1, wherein the service contains information for an upcoming capability or product launch that has not yet occurred, or experimentation information for testing a feature for potential launch.

10. The system of claim 1, wherein the operations further comprise accessing global policy data to apply policy settings to at least one of: globalization default data, language data, region data, market selection data, experimentation data, privacy data, asset purchase offering data, entitlement data, telemetry data, or user experience configuration data to set session context corresponding to the configuration dataset for override, and communicating the payload to the client device.

11. The system of claim 10, wherein the payload is incorporated into a session context object associated with the current client device session.

12. The system of claim 1, wherein the environment comprises functionally-differentiated instances of running services, and wherein the service is an instance, or part of a group of instances, that is capable of servicing requests.

13. The system of claim 11, wherein the functionally differentiated instances of running services comprise partitions, and wherein a partition corresponds to at least one of: a geographic location, or a brand.

14. A method, comprising:
receiving, by a first service comprising a processor, client information from a client device operating at a device-level override or session-level override;
determining, by the first service based on the client information, that the client device is authorized to override a session to experience a particular flavor in an environment;
obtaining, by the first service, policy data comprising configuration data corresponding to the particular flavor;
generating, by the first service, an override payload based on the configuration data; and
returning the override payload to the client device for use during the session in accessing services of the environment.

15. The method of claim 13, further comprising at least one of: allowing access to a second service based on the override payload, in which the second service is inaccessible during a different session that is not based on the override payload, or changing behavior based on the override payload.

16. The method of claim 13, wherein the client device is located in a first geolocation, and further comprising at least one of: changing behavior based on the override payload, or allowing access, based on the override payload, to a second service located in a second geolocation, in which the second service is inaccessible from the first geolocation during a different session that is not based on the override payload.

16. The method of claim 13, further comprising allowing access, based on the override payload, to a second service that accesses future data in response to a request from the client device during the session.

17. The method of claim 13, wherein the session comprises a first session, wherein the services of the environment comprise a first group of services, wherein the override payload is a first override payload, and further comprising returning a second override payload to the client device for use during a second session in accessing the first group of services of the environment.

18. The method of claim 13, wherein the session comprises a first session, wherein the services of the environment comprise a first group of services, wherein the override payload is a first override payload, and further comprising returning a second override payload to the client device that adds to the first override payload.

19. A non-transitory machine-readable medium, comprising executable instructions that, when executed by a processor, facilitate performance of operations, the operations comprising:
maintaining configuration dataset corresponding to client user experiences in an environment;
receiving a client triggered request, from a client device or from a service that received a client device request, request information indicating a particular client user experience; and
in response to the receiving the request information, accessing the configuration dataset to obtain configuration data corresponding to the particular user experience, and sending an override payload based on the configuration data to the client device for use during a client device session to allow the particular client user experience in the environment.

20. The system of claim 1, wherein the operations further comprise routing a client request, based on the particular client user experience, to a service associated with the particular client user experience.
